(19) United States
(12) Patent Application Publication
(10) Pub. No.: US 2026/0169810 A1
(43) Pub. Date: Jun. 18, 2026

(54) METHOD OF PROMPTING FOR IMAGE PROCESSING, ELECTRONIC DEVICE, AND STORAGE MEDIUM

(71) Applicant: Beijing Zitiao Network Technology Co., Ltd., Beijing (CN)

(72) Inventor: Duoyao ZHANG, Beijing (CN)

(21) Appl. No.: 19/412,245

(22) Filed: Dec. 8, 2025

(30) Foreign Application Priority Data
Dec. 13, 2024 (CN) 202411845677.5

(51) Int. Cl. G06F 9/50; G06F 8/71; G06T 1/60

(52) U.S. Cl. CPC G06F 9/5027; G06F 8/71; G06T 1/60

(57) ABSTRACT

The present disclosure provides a method of prompting for image processing, an electronic device, and a storage medium. The method includes: obtaining a first number of pixels supportable for processing by at least one idle resource of a first application; determining, based on the first number of pixels, a second number of pixels currently supportable for processing by the first application; and performing, based on the second number of pixels, an image processing pre-prompt for a first image.

### CROSS-REFERENCE TO RELATED APPLICATION

The present disclosure claims priority of the Chinese Patent Application No. 202411845677.5 filed on Dec. 13, 2024, the disclosure of which is incorporated herein by reference in its entirety as part of the present application.

### TECHNICAL FIELD

The present disclosure relates to a method of prompting for image processing, an electronic device, and a storage medium.

### BACKGROUND

At present, some applications may support users to process images and give a prompt when an abnormality occurs in image processing. However, in the related art, the timing of the image processing prompt is relatively lagged.

### SUMMARY

An embodiment of the present disclosure provides a method of prompting for image processing. The method includes:
obtaining a first number of pixels supportable for processing by at least one idle resource of a first application;
determining, based on the first number of pixels, a second number of pixels currently supportable for processing by the first application; and
performing, based on the second number of pixels, an image processing pre-prompt for a first image.

An embodiment of the present disclosure further provides an apparatus of prompting for image processing. The apparatus includes:
a number obtaining module, configured to obtain a first number of pixels supportable for processing by at least one idle resource of a first application;
a number determination module, configured to determine, based on the first number of pixels, a second number of pixels currently supportable for processing by the first application; and
a pre-prompting module, configured to perform, based on the second number of pixels, an image processing pre-prompt for a first image.

An embodiment of the present disclosure further provides an electronic device. The electronic device includes:
one or more processors; and
a memory configured to store one or more programs, where
the one or more programs, when executed by the one or more processors, cause the one or more processors to implement the method of prompting for image processing according to embodiments of the present disclosure.

An embodiment of the present disclosure further provides a computer-readable storage medium having a computer program stored thereon, where the program, when executed by a processor, implements the method of prompting for image processing according to embodiments of the present disclosure.

An embodiment of the present disclosure further provides a computer program product which, when executed by a computer, causes the computer to implement the method of prompting for image processing according to embodiments of the present disclosure.

### BRIEF DESCRIPTION OF DRAWINGS

The above and other features, advantages, and aspects of embodiments of the present disclosure will become more apparent in combination with the drawings and with reference to the following “Detailed description” part. Throughout the drawings, the same or similar reference numerals denote the same or similar elements. It should be understood that the drawings are schematic and that parts and elements are not necessarily drawn to scale.

FIG. 1 is a schematic flowchart of a method of prompting for image processing according to an embodiment of the present disclosure;

FIG. 2 is a schematic flowchart of a method of prompting for image processing according to an embodiment of the present disclosure;

FIG. 3 is a block diagram of an apparatus for prompting for image processing according to an embodiment of the present disclosure; and

FIG. 4 is a schematic diagram of a structure of an electronic device according to an embodiment of the present disclosure.

### DETAILED DESCRIPTION

Hereinafter, embodiments of the present disclosure will be described in more detail with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only for illustrative purposes and are not intended to limit the protection scope of the present disclosure.

It should be understood that steps described in method implementations of the present disclosure may be performed in different orders and/or in parallel. In addition, the method implementations may include additional steps and/or omit the execution of the steps shown. The scope of the present disclosure is not limited in this respect.

The term “include/comprise” and its variants used herein are open-ended inclusions, that is, “include/comprise but not limited to”. The term “based on” is “at least partially based on”. The term “an embodiment” represents “at least one embodiment”; the term “another embodiment” represents “at least one another embodiment”; and the term “some embodiments” represents “at least some embodiments”. Related definitions of other terms will be given in the description below.

It should be noted that concepts such as “first” and “second” mentioned in the present disclosure are only used to distinguish different apparatuses, modules, or units, and are not used to limit the order or interdependence of functions performed by these apparatuses, modules, or units.

It should be noted that modifications of “a” and “a plurality of” mentioned in the present disclosure are illustrative rather than restrictive, and those skilled in the art should understand that unless otherwise clearly indicated in the context, they should be understood as “one or more”.

The names of messages or information exchanged between a plurality of apparatuses in the implementations of the present disclosure are only used for illustration and are not used to limit the scope of these messages or information.

It may be understood that data involved in the technical solution (including but not limited to the data itself, acquisition or use of the data) should comply with requirements of corresponding laws, regulations, and related provisions.

FIG. 1 is a schematic flowchart of a method of prompting for image processing according to an embodiment of the present disclosure. The method may be performed by an apparatus of prompting for image processing, where the apparatus may be implemented in a form of software and/or hardware, may be configured in an electronic device, and typically may be configured in a computer, a mobile phone, or a tablet computer. The method of prompting for image processing provided in this embodiment of the present disclosure is applicable to a scenario of giving a pre-prompt for image processing before the image processing is performed. As shown in FIG. 1, the method of prompting for image processing provided in this embodiment may include the following steps.
S101: obtaining a first number of pixels supportable for processing by at least one idle resource of a first application.

The first application may be understood as an application used to perform image processing on a current first image, such as an image processing application and/or a media content application supporting image processing. The idle resource may be understood as an image processing resource currently in an idle state. For example, the at least one idle resource may be a remaining available resource of each of at least one type of image processing resource. The at least one idle resource is not limited. Optionally, the at least one idle resource includes idle native memory and/or idle virtual machine memory. The idle native memory may be understood as native memory currently in an idle state, such as remaining available native memory of the first application. The idle virtual machine memory may be understood as virtual machine memory currently in an idle state, such as remaining available Java virtual machine (Java Virtual Machine, JVM) memory of the first application. The first number of pixels supportable for processing by a specific idle resource may be understood as the number of pixels of the idle resource that may be used for processing, such as a maximum number of pixels that may be processed simultaneously.

Specifically, before image processing is performed on the current first image, for example, when an image processing pre-prompt operation is received, a maximum number of pixels currently supportable for processing by each of the at least one idle resource of the first application may be obtained as the first number of pixels of the corresponding idle resource. For example, a maximum number of pixels currently supportable for processing by a first-type idle resource of the first application is obtained as a first number of pixels of the first-type idle resource, and/or a maximum number of pixels currently supportable for processing by a second-type idle resource of the first application is obtained as a second number of pixels of the second-type idle resource. Manners of obtaining the first number of pixels supportable for processing by different types of idle resources may be the same or different, which may be specifically set as required.

In this embodiment, when the first number of pixels is obtained, system version information of the first application may be considered or not. For example, a first number of pixels of at least one preset candidate resource may be obtained, or a first number of pixels of at least one candidate resource corresponding to the system version information of the first application may be obtained. This is not limited in this embodiment.
S102: determining, based on the first number of pixels, a second number of pixels currently supportable for processing by the first application.

The second number of pixels may be understood as the number of pixels currently supportable for processing by the first application, such as a maximum number of pixels currently supportable for simultaneous processing by the first application.

Specifically, after the first number of pixels supportable for processing by each of the at least one idle resource is determined, the second number of pixels currently supportable for processing by the first application may be determined based on the first number of pixels supportable for processing by the respective idle resources. For example, the second number of pixels currently supportable for processing by the first application may be determined based on the first number of pixels in different manners based on differences in idle resources of different types that are required to be used for the image processing.

For example, in the case where each of the at least one idle resource supports independent image processing, that is, in the case where image processing may be performed by using one of the at least one idle resource, a sum of the first number of pixels supportable for processing by each of the at least one idle resource may be calculated as the second number of pixels currently supportable for processing by the first application.

For another example, in the case where the respective idle resources of the at least one idle resource need to perform image processing collaboratively, that is, in the case where the respective idle resources of the at least one idle resource need to be used simultaneously to complete the image processing, a maximum value, a minimum value, an average value, and/or a median value of the first number of pixels supportable for processing by the respective idle resources of the at least one idle resource may be obtained as the second number of pixels currently supportable for processing by the first application.

To further improve the accuracy of the image processing pre-prompt and reduce abnormalities occurring in the image processing process, optionally, the determining, based on the first number of pixels, a second number of pixels currently supportable for processing by the first application includes:
obtaining a minimum value of the respective first number of pixels as the second number of pixels currently supportable for processing by the first application. For example, a minimum value of the first number of pixels supportable for processing by the respective idle resources of the at least one idle resource may be obtained as the second number of pixels currently supportable for processing by the first application. Exemplarily, in the case where the first number of pixels supportable for processing by only one idle resource of the first application is obtained, the first number of pixels supportable for processing by the idle resource is used as the second number of pixels currently supportable for processing by the first application. In the case where the first number of pixels supportable for processing by a plurality of idle resources of the first application is obtained, a smallest first number of pixels may be obtained from the respective first number of pixels as the first number of pixels currently supportable for processing by the first application.
S103: performing, based on the second number of pixels, an image processing pre-prompt for a first image.

Exemplarily, after the second number of pixels currently supportable for processing by the first application is obtained, the image processing pre-prompt for the first image may be performed based on the second number of pixels, such as prompting a maximum number of pixels (that is, the second number of pixels) of the first image that is currently supportable for processing by the first application, and/or prompting, based on the second number of pixels, whether a resource shortage will occur when the current first image is processed, and so on.

In some implementations, the performing, based on the second number of pixels, an image processing pre-prompt for a first image includes: displaying first pre-prompt information for the second number of pixels; and/or performing, based on the second number of pixels and a third number of pixels of the first image, image processing prediction to generate a prediction result, and displaying second pre-prompt information for the prediction result, the prediction result indicating whether a resource shortage will occur when the first image is processed.

The first image may be understood as a current first image. The third number of pixels may be understood as a total number of pixels of the first image, which may be determined based on a user input or determined based on the first image. This is not limited in this embodiment. The prediction result generated by performing the image processing prediction may be used to indicate whether a resource shortage will occur when the first image is currently processed by using the first application. A manner of performing the image processing on the first image is not limited. Exemplarily, the performing image processing on the first image may include, but is not limited to, performing encoding processing, decoding processing, format conversion processing, or the like on the first image.

The first pre-prompt information may be pre-prompt information for the second number of pixels currently supportable for processing by the first application. For example, the first pre-prompt information may be used to prompt the second number of pixels. The second pre-prompt information may be pre-prompt information for the generated prediction result. For example, the second pre-prompt information may be used to prompt the generated prediction result.

In some examples, after the second number of pixels currently supportable for processing by the first application is determined, first preset prompt information may be displayed, and the second number of pixels is prompted by the first pre-prompt information. For example, the first pre-prompt information is used to prompt that a maximum number of pixels currently supportable for processing by the first application is the second number of pixels, and/or to prompt that a number of pixels of the first image that is processed by the user preferably does not exceed the second number of pixels, and so on.

In some examples, after the second number of pixels currently supportable for processing by the first application is determined, based on the second number of pixels and the obtained third number of pixels of the first image, it may be predicted whether a resource shortage will occur when the first image is currently processed by using the first application, to generate the prediction result, and the second pre-prompt information is displayed, and the prediction result is prompted by the second pre-prompt information. For example, the second pre-prompt information is used to prompt whether a resource shortage will occur when the first image is currently processed by using the first application, and so on.

A manner of obtaining the third number of pixels of the first image is not limited. For example, a total number of pixels of the first image that is entered by the user may be obtained as the third number of pixels. Alternatively, a number of row pixels and a number of column pixels of the first image may be obtained from image information of the first image, and the total number of pixels of the first image may be calculated based on the number of row pixels and the number of column pixels. Alternatively, image detection is performed on the first image to obtain the total number of pixels of the first image. This is not limited in this embodiment.

In the preceding implementations, the image processing pre-prompt by using the first pre-prompt information or the second pre-prompt information may be flexibly set as required. In some examples, exemplarily, in the case where the third number of pixels of the first image cannot be obtained, for example, in the case where the user does not enter the total number of pixels of the first image and does not select or import the first image, the image processing pre-prompt may be performed by using the first pre-prompt information. In the case where the third number of pixels of the first image may be obtained, the image processing pre-prompt may be performed by using the second pre-prompt information.

According to the method of prompting for image processing provided in this embodiment, the first number of pixels supportable for processing by the at least one idle resource of the first application is obtained; the second number of pixels currently supportable for processing by the first application is determined based on the first number of pixels; and the image processing pre-prompt for the first image is performed based on the second number of pixels. According to the technical solution described above, this embodiment may dynamically determine the number of pixels currently supportable for processing by the application before the image processing is performed and perform the image processing pre-prompt based on the number of pixels. Compared with the technical solution of giving a prompt only after a resource shortage occurs in an image processing process or performing an image processing pre-prompt based on a preset default number of pixels, this embodiment may not only perform the image processing pre-prompt before the image processing is performed, but also improve the accuracy of the image processing pre-prompt, thereby avoiding waste or shortage of image processing resources and reducing abnormalities occurring in the image processing process.

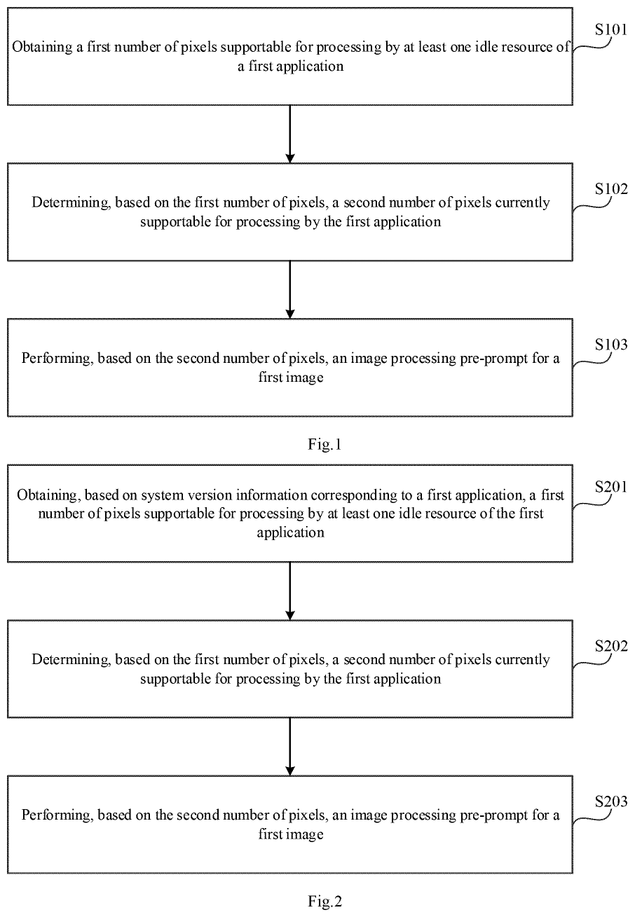

FIG. 2 is a schematic flowchart of a method of prompting for image processing according to an embodiment of the present disclosure. The solution in this embodiment may be combined with one or more optional solutions in the preceding embodiment. Optionally, the obtaining a first number of pixels supportable for processing by at least one idle resource of a first application includes: obtaining, based on system version information corresponding to the first application, the first number of pixels supportable for processing by the at least one idle resource of the first application.

Correspondingly, as shown in FIG. 2, the method of prompting for image processing provided in this embodiment may include the following steps.
S201: obtaining, based on system version information corresponding to a first application, a first number of pixels supportable for processing by at least one idle resource of the first application.

The system version information corresponding to the first application may be understood as information about an operating system version of an electronic device on which the first application is installed, such as an operating system version number of the electronic device on which the first application is installed. When system version information of the first application is different, a type of the idle resource from which the first number of pixels is obtained and/or a manner of obtaining the first number of pixels may be the same or different.

Specifically, the first number of pixels supportable for processing by the at least one idle resource of the first application may be obtained based on the system version information corresponding to the first application. For example, the first number of pixels supportable for processing by at least one idle resource corresponding to the system version information of the first application is obtained, and/or the first number of pixels supportable for processing by the at least one idle resource is obtained by using an obtaining manner corresponding to the system version information of the first application, so as to subsequently determine, based on the obtained first number of pixels supportable for processing by the at least one idle resource, a second number of pixels currently supportable for processing by the first application.

In some implementations, the first number of pixels supportable for processing by different types of idle resources of the first application may be obtained based on whether the system version information corresponding to the first application meets a preset condition, or the first number of pixels supportable for processing by the at least one idle resource of the first application may be obtained by using different obtaining manners.

The preset condition may be set based on differences in image processing resources occupied by different versions of operating systems when image processing is performed. Exemplarily, the preset condition may be that a system version number corresponding to the first application is greater than or equal to a preset system version number. The preset system version number may be set based on actual image processing situations of different versions of operating systems. Taking encoding processing performed on the first image as an example, it is assumed that an operating system with a version number greater than or equal to a specific version number uses a first-type image processing resource to store a bitmap (Bitmap), an array (Array), and an encoding library that are required in the encoding processing process, and an operating system with a version number less than the specific version number uses the first-type image processing resource to store the array and the encoding library required in the encoding process and uses a second-type image processing resource to store the bitmap required in the encoding process, the specific version number may be used as the preset system version number. The following uses this case as an example for description.

In some implementations, the obtaining, based on system version information corresponding to a first application, a first number of pixels supportable for processing by at least one idle resource of the first application includes: in response to the system version information corresponding to the first application meeting a preset condition, calculating, based on first idle resource information of a first-type idle resource of the first application, the first number of pixels supportable for processing by the first-type idle resource; or in response to the system version information corresponding to the first application meeting the preset condition, calculating, based on first idle resource information of a first-type idle resource of the first application, the first number of pixels supportable for processing by the first-type idle resource; and obtaining a preset number of pixels corresponding to a second-type idle resource of the first application as the first number of pixels supportable for processing by the second-type idle resource.

The first-type idle resource may be understood as an idle resource that occupies a relatively large amount of resources when first applications with different system version information perform image processing, such as an idle resource that may have a resource shortage when the first applications with different system version information perform image processing. The second-type idle resource may be understood as an idle resource that only needs to occupy a small amount of resources when a first application whose system version information meets the preset condition performs image processing, in other words, an idle resource that generally does not have a resource shortage when the first application whose system version information meets the preset condition performs image processing. Specific types of the first-type idle resource and the second-type idle resource are not limited, which may be specifically determined based on current image processing and occupancy of various types of image processing resources by the first application when the first application performs the image processing. Exemplarily, the first-type idle resource may include, but is not limited to, idle native memory, and the second-type idle resource may include, but is not limited to, idle virtual machine memory.

The first idle resource information may be understood as resource information of the first-type idle resource, such as a resource value of the first-type idle resource. The preset number of pixels may be set as required. Exemplarily, the preset number of pixels may be set to a value greater than a maximum number of pixels that may be processed by a first-type image processing resource (such as native memory) of the first application. For example, the preset number of pixels may be set to a maximum number of pixels supportable for processing in the case where the second-type image processing resource is completely idle or set to infinity.

Exemplarily, considering that in the case where the system version information corresponding to the first application meets the preset condition, for example, in the case where the system version number corresponding to the first application is greater than or equal to the preset system version number, the first application only needs to occupy a small amount of the second-type image processing resource when performing image processing (such as image encoding processing and the like), and the second-type image processing resource generally does not have a resource shortage, when the second number of pixels currently supportable for processing by the first application is determined, the first number of pixels supportable for processing by the second-type idle resource of the first application may not be considered. For example, the first number of pixels supportable for processing by the first-type idle resource is calculated based on current first idle resource information of the first-type idle resource of the first application, and the second number of pixels currently supportable for processing by the first application is determined based on the first number of pixels. Alternatively, the preset number of pixels supportable for processing by the second-type image processing resource of the first application may be preset, and the preset number of pixels is used as the first number of pixels supportable for processing by the second-type idle resource of the first application, without dynamically calculating, based on second idle resource information of the second-type idle resource, the number of pixels supportable for processing by the second-type idle resource at the current moment, thereby further improving the speed of the image processing pre-prompt.

In some implementations, the obtaining, based on system version information corresponding to a first application, a first number of pixels supportable for processing by at least one idle resource of the first application includes: in response to the system version information corresponding to the first application not meeting a preset condition, calculating, based on first idle resource information of a first-type idle resource of the first application, the first number of pixels supportable for processing by the first-type idle resource; and calculating, based on second idle resource information of a second-type idle resource of the first application, a first number of pixels supportable for processing by the second-type idle resource.

The second idle resource information may be understood as resource information of the second-type idle resource, such as a resource value of the second-type idle resource.

Exemplarily, considering that in the case where the system version information corresponding to the first application does not meet the preset condition, for example, in the case where the system version number corresponding to the first application is less than the preset system version number, both the first-type image processing resource and the second-type image processing resource may have a resource shortage when the first application performs image processing (such as image encoding processing), when the second number of pixels currently supportable for processing by the first application is determined, both the first number of pixels currently supportable for processing by the first-type idle resource of the first application and the first number of pixels currently supportable for processing by the second-type idle resource of the first application may be considered. For example, the first number of pixels currently supportable for processing by the first-type idle resource is determined based on the current first idle resource information of the first-type idle resource, and the first number of pixels currently supportable for processing by the second-type idle resource is determined based on current second idle resource information of the second-type idle resource. The second number of pixels currently supportable for processing by the first application is determined based on the first number of pixels currently supportable for processing by the first-type idle resource and the first number of pixels currently supportable for processing by the second-type idle resource.

In this embodiment, a manner of determining the first number of pixels currently supportable for processing by the first-type idle resource and/or the second-type idle resource is not limited. Exemplarily, the first number of pixels currently supportable for processing by the first-type idle resource may be calculated based on current resource information of the first-type idle resource and resource information of the first-type idle resource occupied by processing of a single pixel, and/or the first number of pixels currently supportable for processing by the second-type idle resource may be calculated based on current resource information of the second-type idle resource and resource information of the second-type idle resource occupied by the processing of the single pixel, and so on.

In some implementations, the calculating, based on first idle resource information of a first-type idle resource of the first application, the first number of pixels supportable for processing by the first-type idle resource includes: invoking a preset resource management object to obtain, through the preset resource management object, the first idle resource information of the first-type idle resource of the first application; determining, using a determination manner corresponding to the system version information, first pixel resource information of the first-type idle resource occupied by processing of a single pixel; and calculating, based on the first idle resource information and the first pixel resource information, the first number of pixels supportable for processing by the first-type idle resource.

The preset resource management object may be an object that performs resource management. The preset resource management object is not limited, provided that the current first idle resource information of the first-type idle resource may be obtained. Exemplarily, the preset resource management object may be an activity manager (Activity Manager) object. The first pixel resource information may be understood as resource information of the first-type idle resource occupied by the processing of the single pixel, such as a resource value of the first-type idle resource occupied by the processing of the single pixel.

Exemplarily, the preset resource management object may be invoked to obtain the first idle resource information of the first-type idle resource of the first application through the preset resource management object. The first pixel resource information of the first-type idle resource occupied by the processing of the single pixel is determined using the determination manner corresponding to the system version information of the first application. The first number of pixels supportable for processing by the first-type idle resource may be calculated based on the first idle resource information and the first pixel resource information, for example, a ratio of a resource value of the first-type idle resource (that is, the first idle resource information) to a resource value of the first-type idle resource occupied by the processing of the single pixel (that is, the first pixel resource information) is calculated, and an integral part of the ratio is used as the first number of pixels supportable for processing by the first-type idle resource.

Using an example in which the first-type idle resource is idle native memory, when the first idle resource information of the first-type idle resource is obtained, exemplarily, an Activity Manager object may be invoked to obtain a memory value of current idle native memory of the first application through the Activity Manager object as the first idle resource information of the first-type idle resource.

Using an example in which the first-type idle resource is idle native memory, the second-type idle resource is idle virtual machine memory, and high efficiency image format (High Efficiency Image Format, HEIC) image encoding processing is performed on the first image, considering that first-type image processing resources occupied by different versions of the first application when the HEIC image encoding processing is performed may be different, the first pixel resource information of the first-type idle resource occupied by the processing of the single pixel may be determined using the determination manner corresponding to the system version information of the first application.

For example, a first application that meets a preset condition (for example, a system version number is greater than or equal to a preset system version number) generally stores a bitmap, an array, and an underlying encoding library in the native memory during HEIC image encoding processing, and therefore a total resource value of memory resources occupied by the bitmap, the array, and the underlying encoding library when a single pixel is processed may be calculated as the first pixel resource information.

For another example, a first application that does not meet a preset condition (for example, a system version number is less than a preset system version number) generally stores an array and an underlying encoding library in the native memory and stores a bitmap in the idle virtual machine memory during HEIC image encoding processing, and therefore a total resource value of memory resources occupied by the array and the underlying encoding library when a single pixel is processed may be calculated as the first pixel resource information.

In some implementations, the calculating, based on second idle resource information of a second-type idle resource of the first application, the first number of pixels supportable for processing by the second-type idle resource includes: obtaining total requestable resource information, requested resource information, and unused resource information that correspond to the second-type idle resource, the unused resource information being resource information of a second-type idle resource that is requested and unused; determining the second idle resource information of the second-type idle resource based on the total requestable resource information, the requested resource information, and the unused resource information; and calculating, based on the second idle resource information and second pixel resource information of the second-type idle resource occupied by processing of a single pixel, a second number of pixels supportable for processing by the second-type idle resource.

The total requestable resource information corresponding to the second-type idle resource may be understood as resource information of the second-type image processing resource requestable by the first application. The requested resource information corresponding to the second-type idle resource may be understood as resource information of the second-type image processing resource currently requested by the first application. The unused resource information corresponding to the second-type idle resource may be understood as resource information of an unused part of the second-type image processing resource currently requested by the first application. Using an example in which the second-type idle resource is an idle virtual machine resource, the total requestable resource information corresponding to the second-type idle resource may be a maximum memory value of virtual machine memory requestable by the first application from an electronic device on which the first application is installed; the requested resource information corresponding to the second-type idle resource may be a memory value of virtual machine memory currently requested by the first application from the electronic device on which the first application is installed; and the unused resource information corresponding to the second-type idle resource may be a memory value corresponding to an unused part of the virtual machine memory requested by the first application. The second pixel resource information may be understood as resource information of the second-type idle resource occupied by the processing of the single pixel, such as a resource value of the second-type idle resource occupied by the processing of the single pixel.

Exemplarily, the total requestable resource information, the requested resource information, and the unused resource information of the unused part of the requested second-type image processing resource that correspond to the first-type idle resource may be obtained.

The second idle resource information of the second-type idle resource is determined based on the requestable resource information, the requested resource information, and the unused resource information. Using an example in which the requestable resource information is a requestable resource value, the requested resource information is a requested resource value, and the unused resource information is an unused resource value, exemplarily, an occupied resource value of the second-type image processing resource may be calculated based on the requested resource value and the unused resource value. For example, a difference between the requested resource value and the unused resource value is calculated as the occupied resource value of the second-type image processing resource. A resource value of the second-type idle resource is further calculated based on the preceding requestable resource value and the occupied resource value. For example, a difference between the preceding requestable resource value and the occupied resource value is calculated as the resource value of the second-type idle resource, and the resource value of the second-type idle resource is used as the second idle resource information of the second-type idle resource.

After the second idle resource information of the second-type idle resource is obtained, the second number of pixels supportable for processing by the second-type idle resource may be calculated based on the second idle resource information and the second pixel resource information of the second-type idle resource occupied by the processing of the single pixel. For example, a ratio of the resource value of the second-type idle resource (that is, the second idle resource information) to a resource value of the second-type idle resource occupied by the processing of the single pixel (that is, the second pixel resource information) is calculated, and an integral part of the ratio is used as the first number of pixels supportable for processing by the second-type idle resource.

In the preceding implementations, a manner of determining the second pixel resource information of the second-type idle resource occupied by the processing of the single pixel is not limited. Using an example in which the first-type idle resource is idle native memory, the second-type idle resource is idle virtual machine memory, and HEIC image encoding processing is performed on the first image, considering that a first application whose system version information does not meet a preset condition (for example, a system version number is less than a preset system version number) generally stores an array and an underlying encoding library in the native memory and stores a bitmap in the idle virtual machine memory during the HEIC image encoding processing, a resource value of a virtual machine resource occupied by the bitmap when a single pixel is processed may be obtained as the second pixel resource information.
S202: determining, based on the first number of pixels, a second number of pixels currently supportable for processing by the first application.
S203: performing, based on the second number of pixels, an image processing pre-prompt for a first image.

According to the method of prompting for image processing provided in this embodiment, the second number of pixels currently supportable for processing by the first application may be determined based on the first number of pixels supportable for processing by the at least one idle resource corresponding to the system version information of the first application, and the image processing pre-prompt for the first image may be performed based on the second number of pixels, to implement the image processing pre-prompt for first applications with different operating system version information, thereby reducing abnormalities occurring in the first application in an image processing process.

Using an example in which the first-type idle resource is idle native memory, the second-type idle resource is idle JVM memory, the first application is an Android application, and HEIC image encoding processing is performed on the first image, in the related art, an encoding application (that is, the first application) generally does not prompt a size of an image supportable for processing or only prompts a preset size (such as 5 k) of an image supportable for processing. However, the user may have a rich use scenario, and may often encounter or need to process a case where the application encodes an ultra-large image (such as an image with a resolution of 1 w×1 w or higher).

In an application encoding scenario, when there are too many pixels in an image to be encoded, a problem of out of memory (Out Of Memory, OOM) easily occurs. For example, too much memory is occupied by other tasks of the first application, resulting in too little memory during encoding, and OOM may occur even when a relatively small image is encoded. And/or, the first application encounters a scenario that an ultra-large image needs to be encoded. Because all pixel information of an original image needs to be basically restored during encoding, this part of encoding memory overhead must be spent. However, because the image is an ultra-large image, a memory space allocated by the Android system to the application is limited, and in this scenario, the ultra-large image may directly cause OOM in the first application.

To address this problem, there is currently no good application programming interface (Application Programming Interface, API) or open source solution due to limited scenarios of using HEIC image encoding, only a small number of users need to encode and upload HEIC images on the application, available memory of a user process during running is constantly changing, it is difficult to give a general standard for the users to refer to, and Android applications have differences in memory space used for Bitmap storage due to different system versions, and it is not easy to give a unified standard.

In view of this, an embodiment of the present disclosure provides a method of prompting for image processing to adapt to different versions of Android systems, and by means of dynamic calculation, the user is informed in advance, before the user performs encoding, whether the existing memory situation may support safe encoding for the first image that needs to be processed next.

Specifically, in the embodiment of the present disclosure, by means of dynamically calculating the memory required for encoding and comparing whether the first application supports encoding the first image at the current stage, OOM caused by encoding a large image may be basically avoided, and the existing memory may be reasonably used, to avoid memory waste on the premise that secure encoding is implemented.

In addition, in this embodiment, the pre-calculation of encoding memory occupancy is compared with the existing memory of the first application, and the compatibility problem of different Android systems is fully considered. Therefore, the method may run on various Android devices whose system version is greater than Android 4.0 (according to statistics, almost all Android devices are currently greater than Android 4.0), and thus has a large scope of application. In addition, in this embodiment, in addition to avoiding the problem of OOM triggered during ultra-large image encoding, the OOM problem introduced by encoding a small image when the application memory is insufficient due to other reasons may also be effectively avoided.

A specific implementation process of the method of prompting an image processing proposed in this embodiment is described as follows:
A system version number (that is, system version information) of the electronic device currently installed with the first application is obtained.

If the system version number is greater than or equal to Android 8.0, an Activity Manager object is invoked to obtain a memory value (that is, first idle resource information) of current idle native memory of the first application through the Activity Manager object. A ratio of the memory value of the idle native memory to a memory value of native memory consumed by a bitmap, an array, and an underlying encoding library in an HEIC image encoding process of a single pixel is calculated as a first number of pixels currently supportable for processing by the idle native memory. In addition, a preset number of pixels of idle JVM memory is obtained as a first number of pixels currently supportable for processing by the idle JVM memory. A minimum value of the first number of pixels currently supportable for processing by the idle native memory and the first number of pixels currently supportable for processing by the idle JVM memory is obtained as a second number of pixels currently supportable for processing by the first application, and an image encoding prompt is performed based on the second number of pixels.

If the system version number is less than Android 8.0, an Activity Manager object is invoked to obtain a memory value (that is, first idle resource information) of current idle native memory of the first application through the Activity Manager object. A ratio of the memory value of the idle native memory to a memory value of native memory consumed by an array and an underlying encoding library in an HEIC image encoding process of a single pixel is calculated as a first number of pixels currently supportable for processing by the idle native memory.

A memory value (that is, total requestable resource information) of the maximum JVM memory requestable by the first application, a memory value (that is, requested resource information) of JVM memory currently requested by the first application, and a memory value (that is, unused resource information) of unused JVM memory in the JVM memory currently requested by the first application are obtained. A difference between the memory value of the JVM memory currently requested and the memory value of the unused JVM memory is calculated as a memory value of the JVM memory occupied by the first application. A difference between the preceding memory value of the JVM memory requested and the memory value of the JVM memory occupied by the first application is calculated as a memory value (that is, second idle resource information) of current idle JVM memory of the first application. A ratio of the memory value of the idle JVM memory to a memory value of JVM memory consumed by a bitmap in the HEIC image encoding process of the single pixel is calculated as a first number of pixels currently supportable for processing by the idle JVM memory.

A minimum value of the first number of pixels currently supportable for processing by the idle native memory and the first number of pixels currently supportable for processing by the idle JVM memory is obtained as a second number of pixels currently supportable for processing by the first application, and an image encoding prompt is performed based on the second number of pixels.

According to the technical solution described above, this embodiment may improve the OOM protection capability of the encoding application and make full use of resources of the encoding application to avoid resource waste.

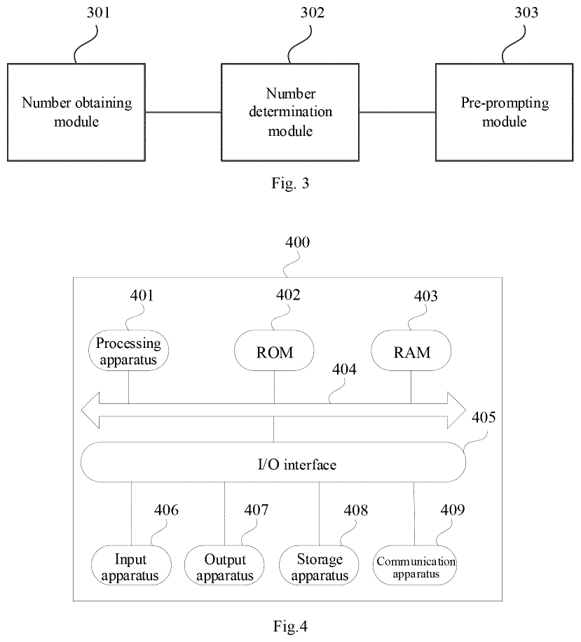

FIG. 3 is a block diagram of an apparatus of prompting for image processing according to an embodiment of the present disclosure. The apparatus may be implemented in a form of software and/or hardware, may be configured in an electronic device, and typically may be configured in a computer, a mobile phone, or a tablet computer, and may give a pre-prompt for image processing before the image processing is performed by performing a method of prompting an image processing. As shown in FIG. 3, the apparatus of prompting for image processing provided in this embodiment may include a number obtaining module 301, a number determination module 302, and a pre-prompting module 303.

The number obtaining module 301 is configured to obtain a first number of pixels supportable for processing by at least one idle resource of a first application.

The number determination module 302 is configured to determine, based on the first number of pixels, a second number of pixels currently supportable for processing by the first application.

The pre-prompting module 303 is configured to perform, based on the second number of pixels, an image processing pre-prompt for a first image.

According to the apparatus of prompting for image processing provided in this embodiment, the first number of pixels supportable for processing by the at least one idle resource of the first application is obtained by the number obtaining module; the second number of pixels currently supportable for processing by the first application is determined by the number determination module based on the first number of pixels; and the image processing pre-prompt for the first image is performed by the pre-prompting module based on the second number of pixels. According to the technical solution described above, this embodiment may dynamically determine the number of pixels currently supportable for processing by the application before the image processing is performed and perform the image processing pre-prompt based on the number of pixels. Compared with the technical solution of giving a prompt only after a resource shortage occurs in an image processing process or perform an image processing pre-prompt based on a preset default number of pixels, this embodiment may not only perform the image processing pre-prompt before the image processing is performed, but also improve the accuracy of the image processing pre-prompt, thereby avoiding waste or shortage of image processing resources and reducing abnormalities occurring in the image processing process.

Optionally, the number obtaining module 301 may be further configured to: obtain, based on system version information corresponding to the first application, the first number of pixels supportable for processing by the at least one idle resource of the first application.

Optionally, the number obtaining module 301 may be further configured to: in response to the system version information corresponding to the first application meeting a preset condition, calculate, based on first idle resource information of a first-type idle resource of the first application, the first number of pixels supportable for processing by the first-type idle resource; or in response to the system version information corresponding to the first application meeting the preset condition, calculate, based on first idle resource information of a first-type idle resource of the first application, the first number of pixels supportable for processing by the first-type idle resource; and obtain a preset number of pixels corresponding to a second-type idle resource of the first application as the first number of pixels supportable for processing by the second-type idle resource.

Optionally, the number obtaining module 301 may be further configured to: in response to the system version information corresponding to the first application not meeting a preset condition, calculate, based on first idle resource information of a first-type idle resource of the first application, the first number of pixels supportable for processing by the first-type idle resource; and calculate, based on second idle resource information of a second-type idle resource of the first application, a first number of pixels supportable for processing by the second-type idle resource.

Optionally, the number obtaining module 301 may include a first information obtaining unit, a first information determination unit, and a first number calculation unit. The first information obtaining unit is configured to invoke a preset resource management object to obtain, through the preset resource management object, first idle resource information of a first-type idle resource of the first application. The first information determination unit is configured to determine, using a determination manner corresponding to the system version information, first pixel resource information of the first-type idle resource occupied by processing of a single pixel. The first number calculation unit is configured to calculate, based on the first idle resource information and the first pixel resource information, the first number of pixels supportable for processing by the first-type idle resource.

Optionally, the number obtaining module 301 may include a second information obtaining unit, a second information determination unit, and a second number calculation unit. The second information obtaining unit is configured to obtain total requestable resource information, requested resource information, and unused resource information that correspond to the second-type idle resource, the unused resource information being resource information of a second-type idle resource that is requested and unused. The second information determination unit is configured to determine the second idle resource information of the second-type idle resource based on the total requestable resource information, the requested resource information, and the unused resource information. The second number calculation unit is configured to calculate, based on the second idle resource information and second pixel resource information of the second-type idle resource occupied by processing of a single pixel, a second number of pixels supportable for processing by the second-type idle resource.

Optionally, the number determination module 302 may be further configured to: obtain a minimum value of the respective first number of pixels as the second number of pixels currently supportable for processing by the first application.

Optionally, the pre-prompting module 303 may be further configured to: display first pre-prompt information for the second number of pixels; and/or perform, based on the second number of pixels and a third number of pixels of the first image, image processing prediction to generate a prediction result, and display second pre-prompt information for the prediction result, the prediction result indicating whether a resource shortage will occur when the first image is processed.

Optionally, the at least one idle resource includes idle native memory and/or idle virtual machine memory.

The apparatus of prompting for image processing provided in this embodiment of the present disclosure may perform the method of prompting for image processing provided in any embodiment of the present disclosure and has functional modules and beneficial effects corresponding to the execution of the method of prompting for image processing. For technical details not described in detail in this embodiment, reference may be made to the method of prompting for image processing provided in any embodiment of the present disclosure.

Reference is made to FIG. 4 below, which illustrates a schematic diagram of a structure of an electronic device (e.g., a terminal device) 400 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 4 is merely an example and should not impose any limitation on the functions and the scope of use of the embodiments of the present disclosure.

As shown in FIG. 4, the electronic device 400 may include a processing apparatus (e.g., a central processing unit, and a graphics processor) 401, which may perform various suitable actions and processing based on a program stored in a read-only memory (ROM) 402 or a program loaded from a storage apparatus 408 into a random access memory (RAM) 403. The RAM 403 further stores various programs and data required for operations of the electronic device 400. The processing apparatus 401, the ROM 402, and the RAM 403 are interconnected by means of a bus 404. An input/output (I/O) interface 405 is also connected to the bus 404.

Usually, the following apparatuses may be connected to the I/O interface 405: an input apparatus 406 including, for example, a touch screen, a touchpad, a keyboard, a mouse, a camera, a microphone, an accelerometer, and a gyroscope; an output apparatus 407 including, for example, a liquid crystal display (LCD), a speaker, and a vibrator; a storage apparatus 408 including, for example, a magnetic tape and a hard disk; and a communication apparatus 409. The communication apparatus 409 may allow the electronic device 400 to perform wireless or wired communication with other devices to exchange data. Although FIG. 4 shows the electronic device 400 having various apparatuses, it should be understood that it is not required to implement or have all the apparatuses shown. More or fewer apparatuses may be implemented or provided alternatively.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program contains program code for performing the method shown in the flowchart. In such an embodiment, the computer program may be downloaded and installed from a network through the communication apparatus 409, or installed from the storage apparatus 408, or installed from the ROM 402. When the computer program is executed by the processing apparatus 401, the preceding functions defined in the method of the embodiment of the present disclosure are executed.

It should be noted that the preceding computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or used in combination with an instruction execution system, apparatus, or device. In the present disclosure, the computer-readable signal medium may include a data signal propagated on a baseband or as a part of a carrier, and computer-readable program code is carried in the data signal. The data signal propagated in this manner may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including, but not limited to, a wire, an optical cable, a radio frequency (RF), or any suitable combination thereof.

In some implementations, an application and a server may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device or may exist alone without being assembled into the electronic device.

The computer-readable medium carries one or more programs, and the one or more programs, when executed by the electronic device, cause the electronic device to: obtain a first number of pixels supportable for processing by at least one idle resource of a first application; determine, based on the first number of pixels, a second number of pixels currently supportable for processing by the first application; and perform, based on the second number of pixels, an image processing pre-prompt for a first image.

The computer program code for performing operations of the present disclosure may be written in one or more programming languages or a combination thereof, where the programming languages include, but are not limited to, an object-oriented programming language such as Java, Smalltalk, and C++, and further include conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the figures illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the figures. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or by hardware. Among them, the name of the module does not constitute a limitation on the unit itself under certain circumstances.

The functions described herein may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store programs for use by an instruction execution system, apparatus, or device, or for use in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

According to one or more embodiments of the present disclosure, Example 1 provides a method of prompting for image processing. The method includes:
obtaining a first number of pixels supportable for processing by at least one idle resource of a first application;
determining, based on the first number of pixels, a second number of pixels currently supportable for processing by the first application; and
performing, based on the second number of pixels, an image processing pre-prompt for a first image.

According to one or more embodiments of the present disclosure, Example 2 relates to the method according to Example 1, and the obtaining a first number of pixels supportable for processing by at least one idle resource of a first application includes:
obtaining, based on system version information corresponding to the first application, the first number of pixels supportable for processing by the at least one idle resource of the first application.

According to one or more embodiments of the present disclosure, Example 3 relates to the method according to Example 2, and the obtaining, based on system version information corresponding to a first application, a first number of pixels supportable for processing by at least one idle resource of the first application includes:
in response to the system version information corresponding to the first application meeting a preset condition, calculating, based on first idle resource information of a first-type idle resource of the first application, the first number of pixels supportable for processing by the first-type idle resource; or
in response to the system version information corresponding to the first application meeting the preset condition, calculating, based on first idle resource information of a first-type idle resource of the first application, the first number of pixels supportable for processing by the first-type idle resource; and obtaining a preset number of pixels corresponding to a second-type idle resource of the first application as the first number of pixels supportable for processing by the second-type idle resource.

According to one or more embodiments of the present disclosure, Example 4 relates to the method according to Example 2, and the obtaining, based on system version information corresponding to a first application, a first number of pixels supportable for processing by at least one idle resource of the first application includes:
in response to the system version information corresponding to the first application not meeting a preset condition, calculating, based on first idle resource information of a first-type idle resource of the first application, the first number of pixels supportable for processing by the first-type idle resource; and calculating, based on second idle resource information of a second-type idle resource of the first application, the first number of pixels supportable for processing by the second-type idle resource.

According to one or more embodiments of the present disclosure, Example 5 relates to the method according to Example 3 or 4, and the calculating, based on first idle resource information of a first-type idle resource of the first application, the first number of pixels supportable for processing by the first-type idle resource includes:
invoking a preset resource management object to obtain, through the preset resource management object, the first idle resource information of the first-type idle resource of the first application;
determining, using a determination manner corresponding to the system version information, first pixel resource information of the first-type idle resource occupied by processing of a single pixel; and
calculating, based on the first idle resource information and the first pixel resource information, the first number of pixels supportable for processing by the first-type idle resource.

According to one or more embodiments of the present disclosure, Example 6 relates to the method according to Example 4, and the calculating, based on second idle resource information of a second-type idle resource of the first application, the first number of pixels supportable for processing by the second-type idle resource includes:
obtaining total requestable resource information, requested resource information, and unused resource information that correspond to the second-type idle resource, the unused resource information being resource information of a second-type idle resource that is requested and unused;
determining the second idle resource information of the second-type idle resource based on the total requestable resource information, the requested resource information, and the unused resource information; and
calculating, based on the second idle resource information and second pixel resource information of the second-type idle resource occupied by processing of a single pixel, a second number of pixels supportable for processing by the second-type idle resource.

According to one or more embodiments of the present disclosure, Example 7 relates to the method according to any one of Examples 1 to 4, and the determining, based on the first number of pixels, a second number of pixels currently supportable for processing by the first application includes:
obtaining a minimum value of the respective first number of pixels as the second number of pixels currently supportable for processing by the first application.

According to one or more embodiments of the present disclosure, Example 8 relates to the method according to any one of Examples 1 to 4, and the performing, based on the second number of pixels, an image processing pre-prompt for a first image includes:
displaying first pre-prompt information for the second number of pixels; and/or
performing, based on the second number of pixels and a third number of pixels of the first image, image processing prediction to generate a prediction result, and displaying second pre-prompt information for the prediction result, the prediction result indicating whether a resource shortage will occur when the first image is processed.

According to one or more embodiments of the present disclosure, Example 9 relates to the method according to any one of Examples 1 to 4, and the at least one idle resource includes idle native memory and/or idle virtual machine memory.

According to one or more embodiments of the present disclosure, Example 10 provides an image processing prompting apparatus. The apparatus includes:
a number obtaining module, configured to obtain a first number of pixels supportable for processing by at least one idle resource of a first application;
a number determination module, configured to determine, based on the first number of pixels, a second number of pixels currently supportable for processing by the first application; and
a pre-prompting module, configured to perform, based on the second number of pixels, an image processing pre-prompt for a first image.

According to one or more embodiments of the present disclosure, Example 11 provides an electronic device. The electronic device includes:
one or more processors; and
a memory, configured to store one or more programs, where
the one or more programs, when executed by the one or more processors, cause the one or more processors to implement the method of prompting for image processing according to any one of Examples 1 to 9.

According to one or more embodiments of the present disclosure, Example 12 provides a computer-readable storage medium having a computer program stored thereon, where the program, when executed by a processor, implements the method of prompting for image processing according to any one of Examples 1 to 9.

According to one or more embodiments of the present disclosure, Example 13 provides a computer program product which, when executed by a computer, causes the computer to implement the method of prompting for image processing according to any one of Examples 1 to 9.

The above description is merely illustration of preferred embodiments of the present disclosure and applied technical principles. Those skilled in the art should understand that the scope of disclosure involved in the present disclosure is not limited to the technical solution formed by a specific combination of the technical features described above, but also covers other technical solutions formed by any combination of the technical features described above or equivalent features thereof without departing from the concept of the present disclosure. For example, the technical solution formed by replacing the preceding features with technical features having similar functions disclosed in the present disclosure (but not limited thereto) also falls within the scope of the present disclosure.

In addition, although the respective operations are depicted in a specific order, this should not be understood as requiring the operations to be performed in the specific order shown or in a sequential order. Under certain circumstances, multitasking and parallel processing may be advantageous. Similarly, although the preceding discussion contains several specific implementation details, these should not be construed as limitations on the scope of the present disclosure. Some features described in the context of separate embodiments may also be implemented in combination in a single embodiment. On the contrary, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms for implementing the claims.

1. A method of prompting for image processing, comprising:
obtaining a first number of pixels supportable for processing by at least one idle resource of a first application;
determining, based on the first number of pixels, a second number of pixels currently supportable for processing by the first application; and
performing, based on the second number of pixels, an image processing pre-prompt for a first image.

2. The method according to claim 1, wherein the obtaining a first number of pixels supportable for processing by at least one idle resource of a first application comprises:
obtaining, based on system version information corresponding to the first application, the first number of pixels supportable for processing by the at least one idle resource of the first application.

3. The method according to claim 2, wherein the obtaining, based on system version information corresponding to the first application, the first number of pixels supportable for processing by the at least one idle resource of the first application comprises:
in response to the system version information corresponding to the first application meeting a preset condition, calculating, based on first idle resource information of a first-type idle resource of the first application, the first number of pixels supportable for processing by the first-type idle resource; or
in response to the system version information corresponding to the first application meeting the preset condition, calculating, based on the first idle resource information of the first-type idle resource of the first application, the first number of pixels supportable for processing by the first-type idle resource; and obtaining a preset number of pixels corresponding to a second-type idle resource of the first application as a first number of pixels supportable for processing by the second-type idle resource.

4. The method according to claim 2, wherein the obtaining, based on system version information corresponding to the first application, the first number of pixels supportable for processing by the at least one idle resource of the first application comprises:
in response to the system version information corresponding to the first application not meeting a preset condition, calculating, based on first idle resource information of a first-type idle resource of the first application, the first number of pixels supportable for processing by the first-type idle resource; and calculating, based on second idle resource information of a second-type idle resource of the first application, the first number of pixels supportable for processing by the second-type idle resource.

5. The method according to claim 3, wherein the calculating, based on the first idle resource information of the first-type idle resource of the first application, a first number of pixels supportable for processing by the first-type idle resource comprises:
invoking a preset resource management object to obtain, through the preset resource management object, the first idle resource information of the first-type idle resource of the first application;
determining, using a determination manner corresponding to the system version information, first pixel resource information of the first-type idle resource occupied by processing of a single pixel; and
calculating, based on the first idle resource information and the first pixel resource information, the first number of pixels supportable for processing by the first-type idle resource.

6. The method according to claim 4, wherein the calculating, based on second idle resource information of a second-type idle resource of the first application, the first number of pixels supportable for processing by the second-type idle resource comprises:
obtaining total requestable resource information, requested resource information, and unused resource information that correspond to the second-type idle resource, the unused resource information being resource information of the second-type idle resource that is requested and unused;
determining the second idle resource information of the second-type idle resource based on the total requestable resource information, the requested resource information, and the unused resource information; and
calculating, based on the second idle resource information and second pixel resource information of the second-type idle resource occupied by processing of a single pixel, a second number of pixels supportable for processing by the second-type idle resource.

7. The method according to claim 1, wherein the determining, based on the first number of pixels, a second number of pixels currently supportable for processing by the first application comprises:
obtaining a minimum value of respective first number of pixels as the second number of pixels currently supportable for processing by the first application.

8. The method according to claim 1, wherein the performing, based on the second number of pixels, an image processing pre-prompt for a first image comprises:
displaying first pre-prompt information for the second number of pixels; and
performing, based on the second number of pixels and a third number of pixels of the first image, image processing prediction to generate a prediction result, and displaying second pre-prompt information for the prediction result, the prediction result indicating whether a resource shortage will occur when the first image is processed.

9. The method according to claim 1, wherein the at least one idle resource comprises idle native memory and idle virtual machine memory.

10. The method according to claim 4, wherein the calculating, based on the first idle resource information of the first-type idle resource of the first application, a first number of pixels supportable for processing by the first-type idle resource comprises:
invoking a preset resource management object to obtain, through the preset resource management object, the first idle resource information of the first-type idle resource of the first application;
determining, using a determination manner corresponding to the system version information, first pixel resource information of the first-type idle resource occupied by processing of a single pixel; and
calculating, based on the first idle resource information and the first pixel resource information, the first number of pixels supportable for processing by the first-type idle resource.

11. The method according to claim 1, wherein the performing, based on the second number of pixels, an image processing pre-prompt for a first image comprises:
displaying first pre-prompt information for the second number of pixels; or,
performing, based on the second number of pixels and a third number of pixels of the first image, image processing prediction to generate a prediction result, and displaying second pre-prompt information for the prediction result, the prediction result indicating whether a resource shortage will occur when the first image is processed.

12. The method according to claim 1, wherein the at least one idle resource comprises idle native memory or idle virtual machine memory.

13. The method according to claim 2, wherein the determining, based on the first number of pixels, a second number of pixels currently supportable for processing by the first application comprises:
obtaining a minimum value of respective first number of pixels as the second number of pixels currently supportable for processing by the first application.

14. The method according to claim 3, wherein the determining, based on the first number of pixels, a second number of pixels currently supportable for processing by the first application comprises:
obtaining a minimum value of respective first number of pixels as the second number of pixels currently supportable for processing by the first application.

15. The method according to claim 4, wherein the determining, based on the first number of pixels, a second number of pixels currently supportable for processing by the first application comprises:
obtaining a minimum value of respective first number of pixels as the second number of pixels currently supportable for processing by the first application.

16. An electronic device, comprising:
at least one processor; and
at least one memory communicatively connected to the at least one processor, wherein the at least one memory has at least one computer program executable by the at least one processor stored thereon, the at least one computer program, when executed by the at least one processor, causes the at least one processor to perform a method of prompting for image processing, and the method comprises:
obtaining a first number of pixels supportable for processing by at least one idle resource of a first application;
determining, based on the first number of pixels, a second number of pixels currently supportable for processing by the first application; and
performing, based on the second number of pixels, an image processing pre-prompt for a first image.

17. The electronic device according to claim 16, wherein the obtaining a first number of pixels supportable for processing by at least one idle resource of a first application comprises:
obtaining, based on system version information corresponding to the first application, the first number of pixels supportable for processing by the at least one idle resource of the first application.

18. The electronic device according to claim 17, wherein the obtaining, based on system version information corresponding to the first application, the first number of pixels supportable for processing by the at least one idle resource of the first application comprises:
in response to the system version information corresponding to the first application meeting a preset condition, calculating, based on first idle resource information of a first-type idle resource of the first application, the first number of pixels supportable for processing by the first-type idle resource; or
in response to the system version information corresponding to the first application meeting the preset condition, calculating, based on the first idle resource information of the first-type idle resource of the first application, the first number of pixels supportable for processing by the first-type idle resource; and obtaining a preset number of pixels corresponding to a second-type idle resource of the first application as a first number of pixels supportable for processing by the second-type idle resource.

19. The method according to claim 17, wherein the obtaining, based on system version information corresponding to the first application, the first number of pixels supportable for processing by the at least one idle resource of the first application comprises:
in response to the system version information corresponding to the first application not meeting a preset condition, calculating, based on first idle resource information of a first-type idle resource of the first application, the first number of pixels supportable for processing by the first-type idle resource; and calculating, based on second idle resource information of a second-type idle resource of the first application, the first number of pixels supportable for processing by the second-type idle resource.

20. A non-transitory computer-readable storage medium having computer instructions stored thereon, wherein the computer instructions, when executed by a processor, cause the processor to implement a method of prompting for image processing, and the method comprises:
obtaining a first number of pixels supportable for processing by at least one idle resource of a first application;
determining, based on the first number of pixels, a second number of pixels currently supportable for processing by the first application; and
performing, based on the second number of pixels, an image processing pre-prompt for a first image.
